(19) United States
(12) Patent Application Publication
(10) Pub. No.: US 2009/0091123 A1
(43) Pub. Date: Apr. 9, 2009

(54) SECURE CARD CARRIER AND METHODS

(76) Inventors: Thomas Raymond Conley, Bloomington, MN (US); Eric Jay Ylvisaker, Blaine, MN (US); Richard Todd Olson, Farmington, MN (US); Joseph Richard Hogan, Plainfield, IL (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/869,046

(22) Filed: Oct. 9, 2007

(51) Int. Cl. B42D 15/00

(52) U.S. Cl. 283/106

(57) ABSTRACT

Embodiments of the invention are related to packaging for stored value cards, amongst other things. One embodiment includes a first panel coupled to a second panel, an activation panel coupled to the second panel, and an opening strip coupled to the second panel, wherein removal of the opening strip releases the activation panel from between the first panel and the second panel. A card can be coupled to the activation panel. In some embodiments the card can be reinserted between the first panel and second panel. Other aspects and embodiments are provided herein.

### TECHNICAL FIELD

This disclosure relates generally to packaging for stored value cards and related methods, amongst other things.

### BACKGROUND OF THE INVENTION

Stored value cards, gift cards, and other pre-paid debit cards are widely used for providing access to goods and services. Such cards are issued by and used at various businesses including major retailers, phone companies, and restaurants. Usually, such stored value cards are displayed on store shelves in an inactivated state. In this way, merchants can provide customers unfettered access to such cards since theft of an inactive card with no intrinsic value is, in general, less of a concern. Typically, such inactivated stored value cards, gift cards, and debit cards are activated at a merchant location or retail store at the time of purchase.

However, such inactive cards can still be susceptible to certain types of fraud. For example, in one particular scheme, thieves first copy down the identifying numbers of unpurchased inactive gift cards hanging in stores. Then the thieves use automated call systems and the identifying numbers to repeatedly check the balances on those cards. Eventually, some of the cards are activated after being purchased by legitimate customers. When this happens, the thieves quickly find out and use the newly activated card numbers to purchase merchandise online before the legitimate customer has a chance to use them. As such, the legitimate customer, the administrator of the card program, and the retailer are exposed to fraud in this type of scheme. Other fraudulent schemes also exist.

Because there is a risk of fraud, both consumers and retailers may lack confidence in unsecure stored value cards, hurting marketability of the cards. Consumers may lack confidence that cards haven't been tampered with making them more hesitant to purchase such cards. Retailers may also lack confidence in the security of stored value cards making them hesitant to sell the cards. To some extent, fraud may taint the reputation of the retailer in the eyes of the consumer. Similarly, fraud may taint the reputation of the company acting as the card administrator in the eyes of the retailer.

For at least these reasons, a significant need exists for packaging materials, systems, and methods that can be used to reduce fraud associated with stored value cards, gift cards, and other pre-paid debit cards.

### SUMMARY OF THE INVENTION

Embodiments of the invention are related to packaging for stored value cards and related methods, amongst other things. In an embodiment, the invention includes a card carrier with an activation panel that can be coupled to a stored value card. The activation panel can be coupled to a second panel or a first panel of a card carrier. The card and the activation panel can be sandwiched between the first panel and the second panel to hide at least a portion of the surface of the card from view before purchase. Upon purchase, the card can be removed via an opening strip, which detaches the activation panel from the first panel and second panel.

Embodiments of the invention can include card carriers, card carrier systems, and methods that can reduce or prevent fraud associated with stored value cards, gift cards, and other pre-paid debit cards. In various embodiments herein, the card is initially in an inactivated state and must be activated before it can be used to purchase goods or services. In some embodiments, card carriers can be configured so that information on the card is obscured from view until the card carrier is opened at the time of purchase and activation of the card. The card carrier can be configured so that it must be opened in order to activate the card. In addition, the card carrier can be configured so that the process of opening it results in an irreversible change so that any tampering prior to purchase will be evident.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

The invention can be more completely understood in connection with the following drawings, in which:

FIG. 1 is a schematic diagram of a card carrier in an unfolded configuration in accordance with at least one embodiment.

FIG. 2 is a first side view of the card carrier shown in FIG. 1 in a folded configuration, in accordance with at least one embodiment.

FIG. 3 is a second side view of the card carrier shown in FIG. 1 in a folded configuration, in accordance with at least one embodiment.

FIG. 4 is a schematic diagram of a card in accordance with at least one embodiment.

FIG. 5 is a schematic diagram of an unfolded card carrier system in accordance with at least one embodiment.

FIG. 6 is a schematic diagram of a partially folded card carrier system in accordance with at least one embodiment.

FIG. 7 is a schematic diagram of a folded card carrier system in accordance with at least one embodiment.

FIG. 8 is a schematic diagram of a card carrier system in a refolded configuration in accordance with at least one embodiment.

FIG. 9 is a schematic diagram of an unfolded card carrier in accordance with at least one embodiment.

FIG. 10 is a schematic diagram of an unfolded card carrier in accordance with at least one embodiment.

FIG. 11 is a schematic diagram of an unfolded card carrier in accordance with at least one embodiment.

FIG. 12 is a flow diagram of an exemplary method in accordance with at least one embodiment.

FIG. 13 is a flow diagram of an exemplary method in accordance with at least one embodiment.

FIG. 14 is a schematic diagram of an unfolded card carrier in accordance with at least one embodiment.

FIG. 15 is a schematic diagram of an unfolded card carrier in accordance with at least one embodiment.

FIG. 16 is a schematic diagram of an unfolded card carrier in accordance with at least one embodiment.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

Embodiments of the invention can include card carriers, card carrier systems, and methods that can reduce or prevent fraud associated with stored value cards, gift cards, and other pre-paid debit cards. In various embodiments herein, the card is initially in an inactivated state and must be activated before it can be used to purchase goods or services. In some embodiments, card carriers can be configured so that information on the card is obscured from view until the card carrier is opened at the time of purchase and activation of the card. The card carrier can be configured so that it must be opened in order to activate the card. In addition, the card carrier can be configured so that the process of opening it results in an irreversible change so that any tampering prior to purchase will be evident. Further aspects of various embodiments will now be described with reference to the figures.

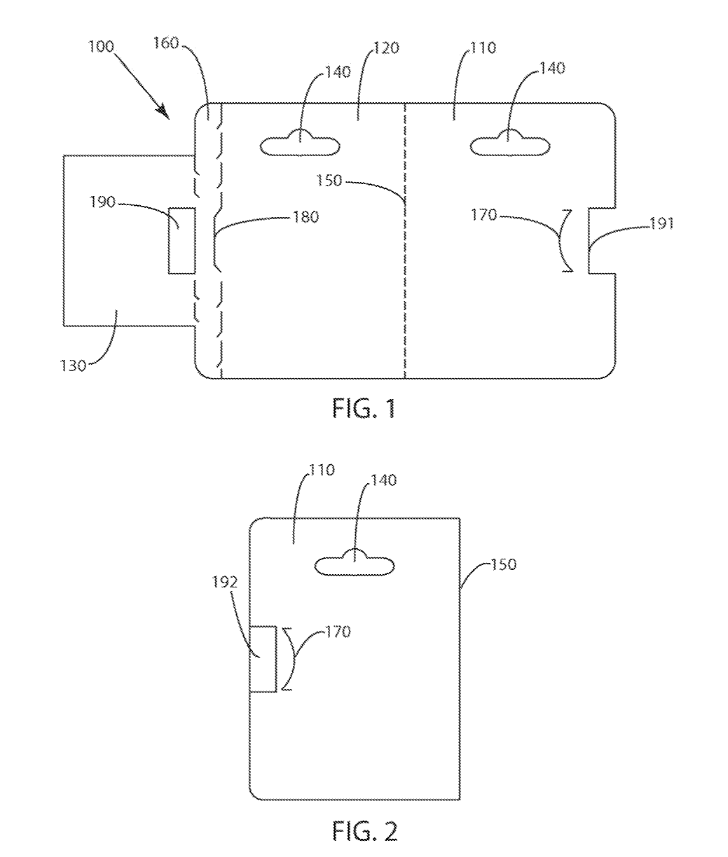

FIG. 1 is a schematic diagram of a card carrier in accordance with at least one embodiment. The card carrier includes a first panel 110 and a second panel 120. A crease 150 can separate the first panel 110 from the second panel 120. The card carrier can also include an activation panel 130. An opening strip 160 can separate the second panel 120 from the activation panel 130.

The card carrier 100 can be configured to hold a card. For example, a card can be coupled to the activation panel 130. The activation panel 130 can fold over the second panel 120, and the first panel 110 can fold over the activation panel 130, so that the activation panel 130 is sandwiched between the first panel 110 and the second panel 120. When a card is placed on the activation panel 130 it, likewise, is sandwiched between the first panel 110 and the second panel 120. This allows information on the card, such as the card activation number, to be hidden from view until opening of the card carrier at the time of purchase of the card.

In at least one embodiment, the opening strip 160 defines perforation lines that separate the second panel 120 from the activation panel 130. The perforations provide a tearing guideline so that tearing of the opening strip 160 preferentially occurs along the lines of perforations. When the opening strip 160 is removed, it allows the card carrier 100 to be opened, giving access to a card within the card carrier 100. Removal of the opening strip 160 also modifies the structure of the card carrier 100 so that it is visually apparent that the card carrier 100 was opened. In some embodiments, when the opening strip 160 is removed, it releases or detaches the activation panel 130 from the rest of the card carrier 100, enabling removal of the activation panel 130 and a card from between the first panel 110 and second panel 120.

In other embodiments, the opening strip 160 may include a cord or string that can be pulled in order to facilitate removal of the opening strip 160.

In some embodiments, the card carrier can be configured to be refolded after initial opening. For example, the second panel 120 can define a reclosure tab 180, and the first panel can define a reclosure tab receptacle 170 that is designed to engage the reclosure tab 180. Removing the opening strip 160 can expose the reclosure tab 180, allowing the card carrier to be secured in a refolded position. For example, as the card is purchased, the opening strip 160 can be removed and the card removed from the activation panel 130. Then the card can be activated and then re-inserted between the first panel 110 and the second panel 120, which can be reclosed in a clamshell configuration via the reclosure tab 180 and the reclosure tab receptacle 170. As such, the card carrier can still be used to hold the card after removal of the opening strip 160. This reclosure feature can be desirable for purposes of using the card carrier to present the card to an end recipient after purchase and activation.

The card carrier can be configured to be hung on a display rack. The first panel 110 and the second panel 120 can define racking apertures 140 which, when the card carrier 100 is folded, allow for racking the card carrier 100 on a store rack. However, in other embodiments, the racking apertures can be omitted. The racking apertures 140, in at least one embodiment, can be formed by punching out or die cutting material in the first panel 110 and the second panel 120. The racking apertures 140 can be of any shape, size, and location sufficient to enable display of the card carrier 100 on a display rack.

In general, the card carrier functions to obscure the view of the card and information thereon. However, in some cases it can be desirable to have at least a portion of the card visible from outside of the card carrier when in a folded configuration. In some embodiments, the activation panel 130 can define an aperture 190 and the first panel 110 can define a notch 191. The aperture 190 of the activation panel 130 and the notch 191 of the first panel 110 can provide a window so that a particular portion of the card can be viewed from outside of the card carrier 100. Specifically, the window can enable viewing of information such as a sequential identifying number that may be useful in determining which cards came together in a particular shipment of cards. The aperture 190 and notch 191 can be located at any point where viewing the information on the card is desired, and can be sized as necessary to view such information. In general, the aperture 190 and notch 191 are sufficiently small so that only a portion of the card is viewable from outside of the card carrier. The aperture 190 and notch 191 can be formed by punching out or die cutting the relevant area of the first panel 110 and the activation panel 130. However, it will be appreciated that the aperture 190 and notch 191 can also be created using other techniques known to those of skill in the art.

The first panel 110, second panel 120, activation panel 130, and opening strip 160 can be comprised of a single material. In addition, the first panel 110, second panel 120, activation panel 130, and opening strip 160 also can be constructed from a single sheet of a single material. However, in other embodiments, the first panel 110, second panel 120, activation panel 130, and opening strip 160 can include multiple materials and/or can be constructed from multiple sheets. Exemplary materials can include but are not limited to cellulosic materials such as paper, card stock, cardboard, and the like. Exemplary materials can also include polymers, metal foils, and the like.

In general, the material used for portions of the card carrier is thin enough to be folded and form the crease 150. In some embodiments, the material is less than or equal to about 38 mils (or less than or equal to about 38 points in thickness). In some embodiments, the material is less or equal to about 16 mils. In general, the material is thick enough to facilitate cleanly tearing off the opening strip 160. The material is generally also thick enough so as to substantially resist potential deformation caused by application of adhesive. In some embodiments, the material is greater than or equal to about 6 mils. In some embodiments, the material is greater than or equal to about 8 mils.

In some embodiments, the first panel 110, second panel 120, activation panel 130, and/or opening strip 160 are from about 6 to about 38 mils (or points) in thickness. In some embodiments, the first panel 110, second panel 120, activation panel 130, and/or opening strip 160 are from about 8 to about 16 mils in thickness. In at least one embodiment, the first panel 110, second panel 120, activation panel 130, and/or opening strip 160 are about 12 mils in thickness.

The material of the card carrier can be coated on one side or both sides to facilitate printing on the coated surface of the card stock. The material could also be coated for aesthetic benefits. In some embodiments, the card carrier 100 is coated and printed on one side of the card carrier 100. For example, the card carrier 100 can be coated and printed on its outside surfaces to identify the type of card being carried and make the card carrier more visually appealing. In some embodiments, printing can also be included on the inside of the card carrier. For example, high visibility printing can be included on portions of the inside of the card carrier so that any tampering with the card carrier will be highly visible. In some embodiments security ink can be printed on to portions of the inside of the card carrier to make tampering evident.

Printing on the card carrier can be performed through various techniques known to those of skill in the art. Exemplary printing techniques can include, but are not limited to flexographic printing, gravure printing, lithographic printing, screen printing, letterpress, various plateless printing processes, or the like.

Information designed to be obscured from view until purchase can be printed on the activation panel 130. For example, a UPC can be printed on the activation panel 130. In some embodiments, activation information can be printed on the activation panel 130. A UPC also can be printed on either the first panel 110 or second panel 120.

In contrast, items designed to catch the attention of consumers can, as an example, be printed on the outside of the card carrier 100. As another example, the information pertaining to the type of card included in the card carrier 100 can be printed on the outside of the card carrier 100 for communication to potential consumers or recipients. However, information printed on the outside of the card carrier 100 generally omits activation information, so as to deter fraudulent use of the card.

FIG. 2 is a first side view of the card carrier of FIG. 1 shown in a folded configuration in accordance with at least one embodiment. In this view of the folded card carrier 100, the front panel 110 is visible with the second panel 120 (pictured in FIG. 1) folded behind, and the activation panel 130 (pictured in FIG. 1) folded between the first panel 110 and the second panel 120. The first panel 110 and the second panel 120 include the racking apertures 140. The aperture 190 in the activation panel 130 and the notch 191 in the first panel 110 form a window 192. Also shown is the reclosure tab receptacle 170.

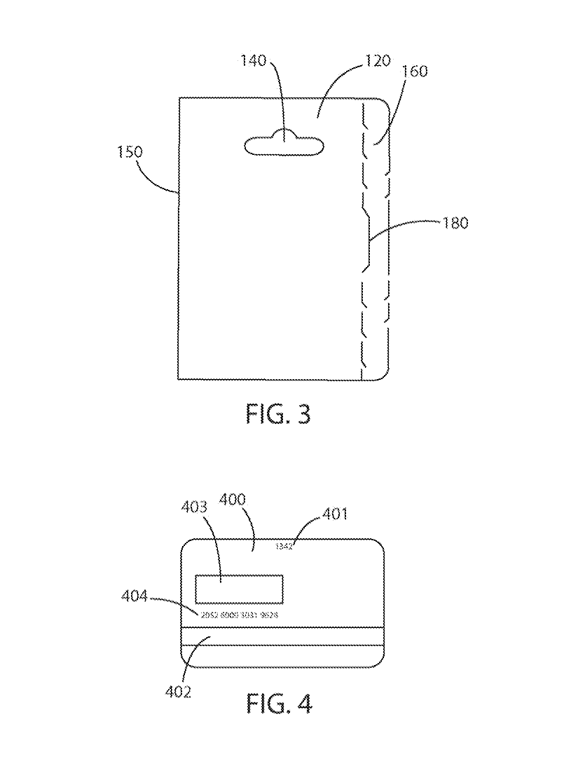

FIG. 3 is a second side view of the card carrier of FIG. 1 shown in a folded configuration in accordance with at least one embodiment. In this view, the second panel 120 is visible with the first panel 110 (pictured in FIG. 1) folded behind, and the activation panel 130 (pictured in FIG. 1) folded between the first panel 110 and the second panel 120. The second panel 120 and perforations defined by the opening strip 160 defines the reclosure tab 180. The racking apertures 140 are also visible on this side of the card carrier 100.

FIG. 4 is a schematic diagram of an exemplary card 400 (such as stored value card, gift card, or other pre-paid debit card) in accordance with at least one embodiment. The card 400 can be any type of card used for providing access to goods and services such as stored value cards, gift cards, or other pre-paid debit cards. The card 400 can be issued to consumers or used by retailers, phone companies, restaurants, and the like (hereinafter “merchant”). The card 400 can have many different embodiments, and can be made out of various materials including, but not limited to, a plastic or card stock.

The card 400 can have a sequential inventory number 401 associated with the card. The card 400 can also have a magnetic stripe 402 that contains data relevant to operation and use of the card 400. The magnetic stripe typically contains data such as the card value and/or the card account number 404 (discussed below), for example. In some embodiments, the magnetic stripe can be replaced by or used in conjunction with a microprocessor chip and volatile or nonvolatile memory storage components, as in contact- or contactless-smart cards.

The card 400 can also have a UPC (Universal Product Code) bar code 403 disposed thereon. The UPC bar code 403 can be located anywhere on the card. However, in some embodiments, the UPC bar code 403 is not on the card at all. In some embodiments, the UPC bar code can be obscured from view when the card carrier 100 is in a folded configuration.

The card 400 can have an account number 404 disposed thereon. The account number 404 can be associated with the individual card 400 and can be used for activation of the card 400.

It will be appreciated that other information can also be contained on the card 400. By way of example, a PIN number, a second account number, an authorization number, or the like can also be contained on the card.

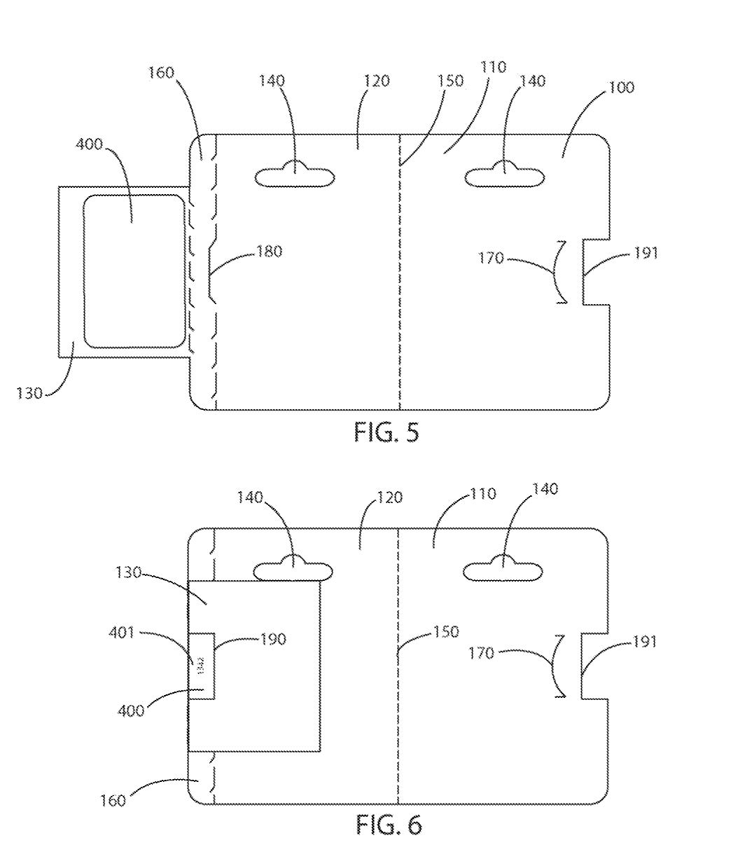

FIG. 5 is a schematic diagram of an unfolded card carrier system in accordance with at least one embodiment. The card carrier system can include a card 400 and a card carrier 100. The card 400 (discussed above regarding FIG. 4) is shown disposed on the activation panel 130. In the embodiment shown, the surface area of the activation panel 130 is larger than the surface area of the card 400. However, in other embodiments the surface area of the activation panel 130 can be the same size as or smaller than the card 400.

The card 400 can be coupled to the activation panel 130 through any desirable means. In some embodiments, the card 400 is attached to the activation panel 130 in a manner that prevents the card 400 from substantially repositioning while attached, but allows removal of the card 400 before use. The card 400 can be attached with an adhesive, for example, or with double-sided tape in another example. In some embodiments, the card 400 can be attached to the activation panel 130 via one or more pockets, straps, or the like.

FIG. 6 is a schematic diagram of a partially folded card carrier system in accordance with at least one embodiment. Here, starting from the position depicted in FIG. 5, the activation panel 130 is folded over the second panel 120 with the card 400 in between the two. The inventory number 401 on the card 400 is visible through the aperture 190.

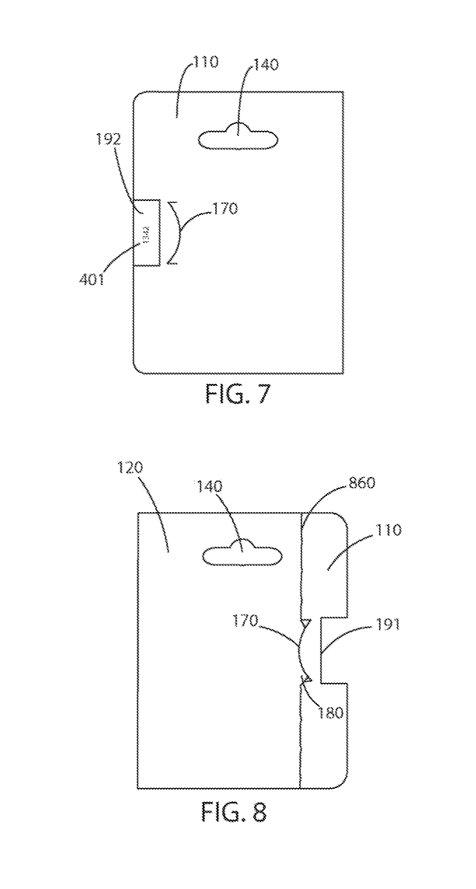

FIG. 7 is a schematic diagram of a folded card carrier system in accordance with at least one embodiment. Here, starting from the position represented in FIG. 6, the first panel 110 is folded over the activation panel 130 (shown in FIG. 6) and the second panel 120 (shown in FIG. 6). The card 400 is sandwiched between the second panel 120, and the activation panel 130 and the first panel 110. The notch 191 on the first panel 110 substantially aligns with the aperture 190 on the activation panel 130 to form a window 192, so that the inventory number 401 is viewable from outside the card carrier 100.

FIG. 8 is a schematic diagram of a card carrier system in a refolded position, in accordance with at least one embodiment. Here, the opening strip 160 (depicted in FIG. 5) has been removed which allows removal of the activation panel 130 (depicted in FIG. 5) and the card 400 (depicted in FIG. 5). The card 400 can be reinserted between the first panel 110 and the second panel 120. The removal of the opening tab 160 reveals the reclosure tab 180 along the perforation remainder edge 860. The perforation remainder edge 860 is the edge that remains after the opening strip 160 is removed. When the card carrier 100 is refolded, the reclosure tab 180 is received by the reclosure tab receptacle 170. As discussed above in the FIG. 1 description, the reclosure mechanism can be any type mechanism that allows reclosure of the card carrier 100 once the opening strip 190 has been removed.

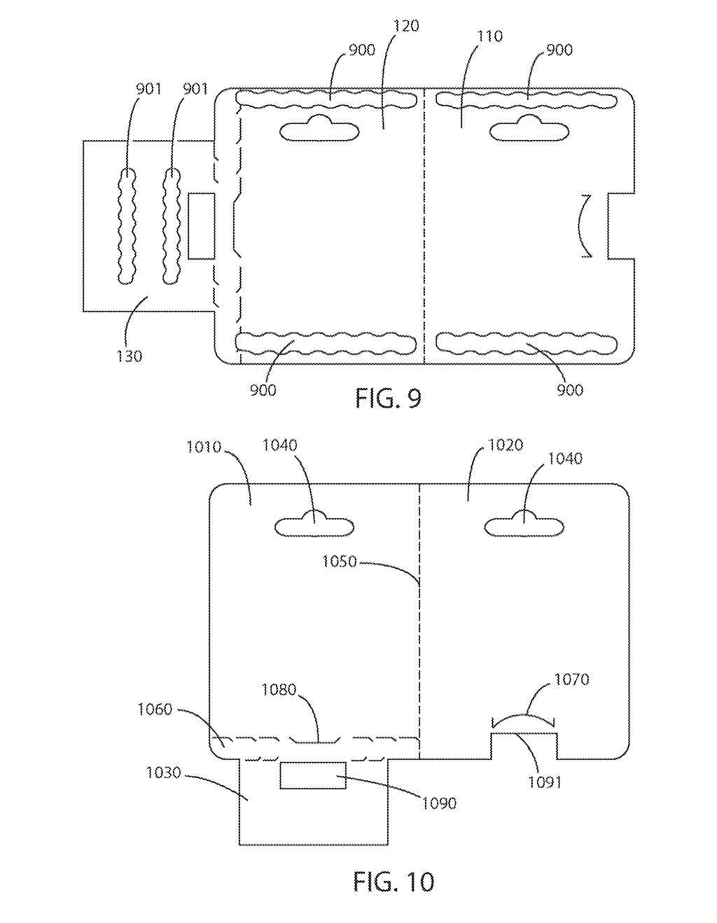

An adhesive may be used to fasten the first panel 110 to the second panel 120 and maintain the card carrier in a folded configuration. FIG. 9 is a schematic diagram showing exemplary adhesive distribution on an unfolded card carrier, in accordance with at least one embodiment. First adhesive 900 is distributed on the first panel 110 and the second panel 120. First adhesive 900 can be used to keep the first panel 110 folded over the second panel 120. The first adhesive 900 distributed on the first panel 110 and second panel 120 can be any type of adhesive that is sufficient to bind the first panel 110 to the second panel 120 under the conditions of use. The adhesive can be considered permanent, relative to the useful life of the card carrier 100 (shown in FIG. 1). As examples, the first adhesive can be reactive, pressure sensitive, drying, thermoplastic, or any other type of adhesive. In some embodiments, the first adhesive need only be distributed on either the first panel 110 or the second panel 120, individually, rather than on both. It will be appreciated that the first adhesive 900 can also be distributed in patterns other than that shown in FIG. 9.

A second adhesive 901 can be distributed on the activation panel 130, according to some embodiments. The second adhesive can be used to couple the card to the activation panel 130. The second adhesive 901 distributed on the activation panel 130 is for the purpose of securing the card 400 (depicted in FIG. 5) to the activation panel 130. In some embodiments, when the card 400 is purchased, the card 400 can be removed from the activation panel 130. However, in other embodiments, the card 400 can remain attached to the activation panel 130 even after purchase. Many types of adhesive can be used as the second adhesive 901. This can include, for example, rubber-based adhesives, thermoplastic adhesives, or pressure sensitive adhesives (such as double-sided tape). In some embodiments, a peelable glue, sometimes referred to as fugitive glue, can be used as the second adhesive 901. An advantage of using fugitive glue as the second adhesive 901 is that it can be peeled off the card 400, if so desired. It will be appreciated that the second adhesive 901 can also be distributed in patterns other than that shown in FIG. 9.

In some embodiments, including the one depicted in FIG. 1, the activation panel 130 is coupled to the second panel 120 along an axis parallel to the crease 150 separating the first panel 110 from the second panel 120. However, in other embodiments, the activation panel can be coupled to the second panel along an axis perpendicular to the crease separating the first panel from the second panel. Referring now to FIG. 10, a schematic diagram is shown of a disassembled card carrier in accordance with at least one embodiment. A first panel 1010 is separated from a second panel 1020 via a crease 1050. The first panel 1010 and the second panel 1020 define racking apertures 1040. The card carrier can also include a reclosure mechanism that comprises a reclosure tab 1080 and a reclosure tab receptacle 1070. In this embodiment, the activation panel 1030 is coupled to the second panel 1010 along an axis perpendicular to the crease 1050. An opening strip 1060 is disposed between the activation panel 1030 and the second panel 1020. The activation panel 1030 defines an aperture 1090 and the first panel 1010 defines a notch 1091.

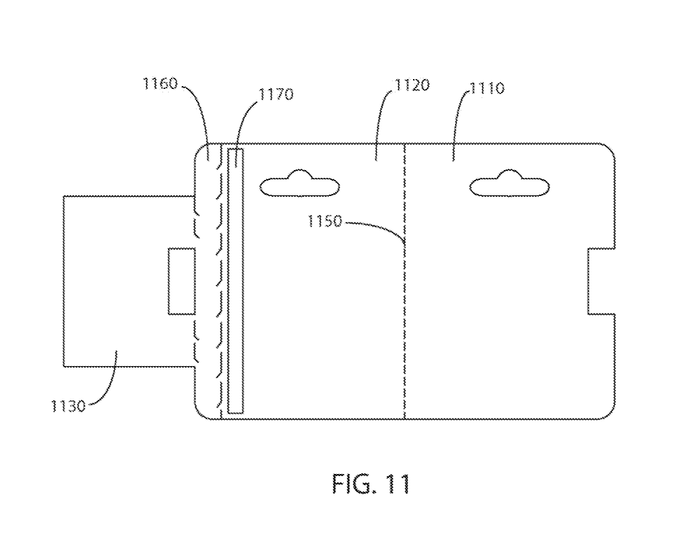

In some embodiments, card carriers can include reclosure mechanisms including a reclosure tab and a reclosure tab receptacle. However, embodiments can also include other features to facilitate reclosure of the card carrier. Referring now to FIG. 11, a schematic diagram is shown of an unfolded card carrier, in accordance with at least one embodiment. A first panel 1110 is coupled to a second panel 1120 along a crease 1150. The activation panel 1130 is coupled to the second panel 1110 parallel to the crease 1150. An opening strip 1160 is disposed between the activation panel 1130 and the second panel 1120. The card carrier includes a reclosure mechanism that includes an adhesive strip 1170. A release liner (not shown) can be disposed over the adhesive strip 11170.

When reclosure of the card carrier is desired, the release liner can be removed exposing the adhesive strip 1170, which can then be used to secure the card carrier 1100 in a reclosed configuration. For example, once the opening strip is removed 1160 and the card carrier 1100 needs to be reclosed, the release liner can be removed, exposing the adhesive strip 1170 and allowing the adhesive strip 1170 to engage the first panel 1110 and hold the card carrier 1100 in a closed position. In an additional embodiment, the adhesive strip 1170 can be disposed on the first panel 1110 and, once the release liner is removed, the adhesive strip 1170 can engage the second panel 1120.

Embodiments of card carrier can also include other features for securing the card carrier in a closed position after initial opening of the card carrier. By way of example, the card carrier can include a flap than can be folded over to secure the card carrier in a closed position after initial opening.

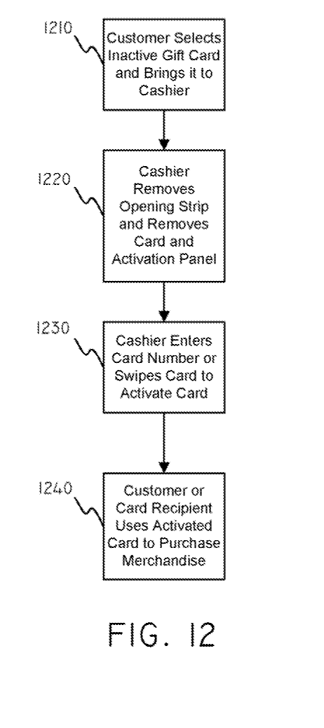

FIG. 12 is a flow chart of an exemplary method in accordance with at least one embodiment. In this method, the customer first selects an inactive gift card and brings it to the cashier 1210. When the customer selects an inactive gift card and brings it to the cashier, the customer is generally selecting the gift card off of a sales rack with the card in the card carrier system. Because of features of various embodiments described herein, if the card inside of the card carrier system has been viewed before purchase, the packaging will be irreversibly altered, making potential tampering clear to anyone viewing the card carrier.

Next, the cashier removes the opening strip and removes the card and activation panel 1220. In some embodiments, removing the opening strip causes the card carrier to be altered in appearance, making it clear that the card carrier has been opened. In some embodiments, removing the opening strip may reveal high visibility ink (such as dayglo orange or neon green) that makes it clear that the card carrier has been opened. In some embodiments, removing the opening strip may expose security ink to indicate that the card carrier has been opened.

In embodiments such as that depicted in FIG. 1, the cashier would simply tear the opening strip off via perforations along each side of the opening strip to remove the opening strip. The activation panel, which has the card attached thereto, would then be released from either the first panel or second panel, and it could be manually removed along with the card.

Then, the cashier enters the card number or swipes the card to activate the card 1230. The card number or data obtained from swiping the magnetic stripe on the card can be entered into a centralized computer system, for example, that identifies the account and activates the account. Many different methods exist for activating a card. Technical data processing details regarding card activation are known to those of skill in the art. For example, some activation techniques are described in U.S. Pub. Pat. App. No. 2007/0187488, the content of which is herein incorporated by reference.

Finally, the customer or card recipient can use the activated card to purchase merchandise 1240. Purchasing merchandise with the card can occur through any means known of making purchases with stored value cards. In some embodiments, the recipient can use the card to obtain services, make telephone calls, eat at a restaurant, rent videos, or obtain any other product or service that can be traded for at least some of the value of the card.

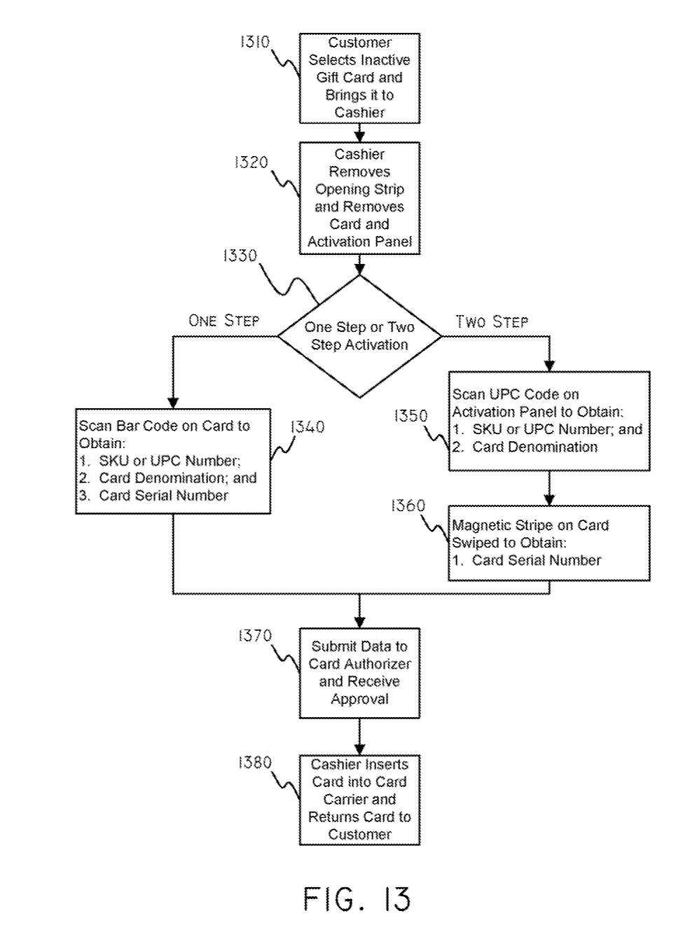

FIG. 13 is a flow diagram of an exemplary method in accordance with at least one embodiment. In this method, the customer first selects an inactive gift card and brings it to the cashier 1310. Next, the cashier removes the opening strip and removes the card and activation panel 1320. In embodiments such as that depicted in FIG. 1, the cashier would simply tear the opening strip off via perforations along each side of the opening strip. The activation panel, which has the card attached thereto, would then be released from either the first panel or second panel, and it could be removed along with the card.

Activation 1330 of the card can then take place via either a one step or a two step process. In the exemplary one step activation process 1340, the bar code can be scanned to obtain the SKU or UPC number, the card denomination, and the card serial number. In the exemplary two step activation process, the UPC code on the activation panel can be scanned to obtain the SKU or UPC number and the card denomination in one step 1350. In a separate step 1360, the card serial number can be obtained by swiping the magnetic stripe on the card.

In both the one step and two step activation processes, the data that is obtained from the card or activation panel is submitted to a card authorizer for approval 1370. The card authorizer can be a centralized computer system, for example, that receives card data and processes the data to identify the account and activate the account. Many different methods exist for activating a card. In some embodiments, the customer or card recipient can activate the card after purchase through a telephone line or on the internet Technical details regarding card activation are known to those of skill in the art.

Finally, the cashier inserts the card into the card carrier and returns the card to the customer 1380. The card can be inserted between the first panel and the second panel, and the reclosure mechanism can be engaged. After the purchasing process, the customer or card recipient can use the activated card to purchase merchandise. As noted above, in some embodiments, the customer can activate the card after purchasing the card.

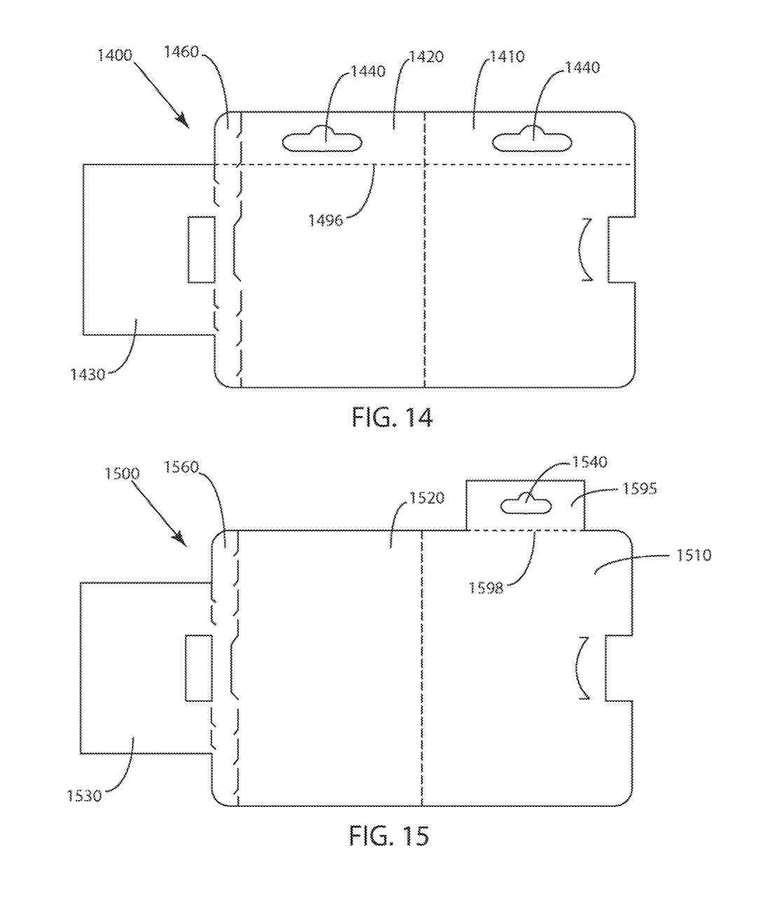

In some embodiments, card carriers can be configured so a portion including the racking apertures can be removed, such as by tearing along a perforation line. Referring now to FIG. 14, an embodiment of a card carrier 1400 is shown in accordance with an embodiment of the invention. A first panel 1410 is coupled to a second panel 1420. An activation panel 1430 is coupled to the second panel 1420. An opening strip 1460 is disposed between the activation panel 1430 and the second panel 1420. Racking apertures 1440 are disposed on the first panel 1410 and the second panel 1420. A perforation line 1496 can separate the area adjacent to the racking apertures 1440 from the rest of the first panel 1410 and the second panel 1420. As such, the portion of the card carrier including the racking apertures 1440 can be removed by tearing along the perforation line 1496.

In some embodiments, racking apertures can be disposed on a separate panel of the card carrier. Referring now to FIG. 15, an embodiment of a card carrier 1500 is shown in accordance with an embodiment of the invention. A first panel 1510 is coupled to a second panel 1520. An activation panel 1530 is coupled to the second panel 1520. An opening strip 1560 is disposed between the activation panel 1530 and the second panel 1520. A racking aperture 1540 is disposed on a racking panel 1595 that is coupled to the first panel 1510. In some embodiments, a perforation line 1598 can be disposed between the racking panel 1595 and the first panel 1510. As such, the racking panel 1595 can be removed by tearing along the perforation line 1598.

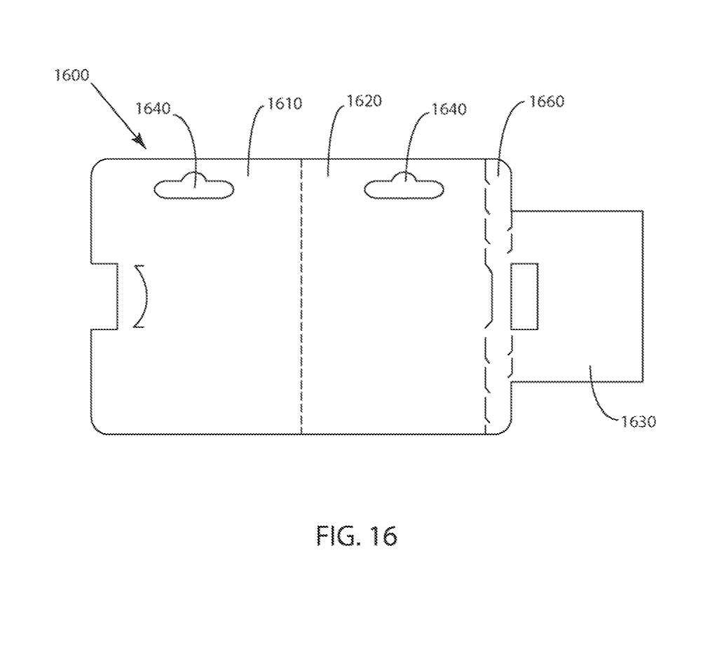

It will be appreciated that the orientation of specific elements described herein can be changed in various embodiments. By way of example, elements depicted as being on a particular side can also be disposed on an opposite side. Referring now to FIG. 16, a card carrier 1600 is shown in accordance with an embodiment of the invention. The card carrier 1600 of FIG. 16 is similar to that of FIG. 1 but different in that the elements are arranged on different sides. A first panel 1610 is coupled to a second panel 1620. An activation panel 1630 is coupled to the second panel 1620. An opening strip 1660 is disposed between the activation panel 1630 and the second panel 1620. Racking apertures 1640 are disposed on the first panel 1610 and the second panel 1620.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

One of ordinary skill in the art will understand that the operations, circuitry, and methods shown and described herein with regard to various embodiments of the invention can be implemented using software, hardware, and combinations of software and hardware. As such, the illustrated and/or described operations, circuitry, and methods are intended to encompass software implementations, hardware implementations, and software and hardware implementations.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A card carrier comprising:
a first panel;
a second panel coupled to the first panel;
an activation panel coupled to the second panel; and
an opening strip coupled to the second panel, wherein removal of the opening strip releases the activation panel from the second panel.

2. The card carrier of claim 1, further comprising a reclosure mechanism.

3. The card carrier of claim 2, the reclosure mechanism comprising a reclosure tab disposed on the second panel and a reclosure tab receptacle disposed on the first panel.

4. The card carrier of claim 3, wherein removal of the opening strip exposes the reclosure tab.

5. The card carrier of claim 1, the activation panel further defining an aperture, the aperture visible from the outside of the card carrier when the card carrier is in a folded configuration.

6. The card carrier of claim 1, wherein a crease separates the first panel from the second panel; the activation panel coupled to the second panel along an axis parallel to the crease separating the first panel from the second panel.

7. The card carrier of claim 1, wherein a crease separates the first panel from the second panel; the activation panel coupled to the second panel along an axis perpendicular to the crease separating the first panel from the second panel.

8. The card carrier of claim 1, the activation panel comprising a UPC barcode, wherein the UPC barcode is obscured from view when the card carrier is in a folded configuration.

9. The card carrier of claim 1, the first panel and second panel comprising a cellulosic material with a thickness of between about 6 mils and about 38 mils.

10. The card carrier of claim 1, the first panel and the second panel defining a racking aperture.

11. The card carrier of claim 1, the first panel folded over the second panel, further comprising an adhesive bonding the first panel to the second panel.

12. A card carrier system comprising:
a card; and
a card carrier comprising
a first panel;
a second panel coupled to the first panel;
an activation panel coupled to the second panel, the card coupled to the activation panel; and
an opening strip coupled to the second panel, wherein removal of the opening strip releases the card and the activation panel from between the first panel and the second panel.

13. The card carrier system of claim 12, the activation panel further defining an aperture, wherein a portion of the card is visible from outside of the card carrier through the aperture.

14. The card carrier system of claim 12, wherein a crease separates the first panel from the second panel; the activation panel coupled to the second panel along an axis parallel to the crease separating the first panel from the second panel.

15. The card carrier system of claim 12, wherein a crease separates the first panel from the second panel; the activation panel coupled to the second panel along an axis perpendicular to the crease separating the first panel from the second panel.

16. The card carrier system of claim 12, the activation panel comprising a UPC barcode, wherein the UPC barcode is obscured from view when the card carrier is in a folded configuration.

17. The card carrier system of claim 12, the card disposed between the first panel and the second panel, wherein the card is inactive and must be removed from between the first panel and the second panel in order to be activated.

18. The card carrier system of claim 12, the card comprising a magnetic strip that can be encoded with data.

19. The card carrier system of claim 12, wherein the opening strip is irreversibly removable from the second panel.

20. A method of activating a stored value card, the method comprising:
releasing an activation panel and the stored value card from between a first panel and a second panel of a card carrier by removing an opening strip; and
activating the stored value card using information found on the activation panel and/or the stored value card.
